(19) United States
(12) Patent Application Publication
(10) Pub. No.: US 2026/0238678 A1
(43) Pub. Date: Aug. 13, 2026

(54) BACK-TRACING DDOS ATTACKS

(71) Applicant: NetScout Systems, Inc., Westford, MA (US)

(72) Inventors: Steinthor Bjarnason, Fjerdingby (NO); Marcin Nawrocki, Berlin (DE)

(73) Assignee: NetScout Systems, Inc., Westford, MA (US)

(21) Appl. No.: 19/052,248

(22) Filed: Feb. 12, 2025

(51) Int. Cl. H04L 9/40

(52) U.S. Cl. CPC H04L 63/1458; H04L 63/1425

(57) ABSTRACT

A system can include one or more memory devices that can store instructions thereon. The instructions can, when executed by one or more processors, cause the one or more processors to monitor network traffic across a network provided by a first autonomous system, detect an attack on an Internet Protocol (IP) address of the network, prompt a network device for one or more flow records that list (i) the IP address of the network as a destination IP address, and (ii) the first autonomous system as a destination autonomous system, generate a first node that comprises at least one of (i) the IP address of the network within the graph or (ii) an identification of the first autonomous system within the graph, and detect that at least one flow record of the one or more flow records lists the first autonomous system as a next hop autonomous system.

### BACKGROUND

Distributed denial of service (DDoS) attacks may be forwarded across one or more networks or across one or more internet service providers.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 is an illustration of a system for back-tracing one or more DDoS Attacks, in accordance with an implementation;

FIG. 2 is an illustration of a flow diagram of a process to generate a graph for back-tracing one or more DDoS attacks, in accordance with an implementation;

FIG. 3 is an illustration of a graph for back-tracing one or more DDoS attacks, in accordance with an implementation;

FIG. 4 is an illustration of one or more disconnected nodes for a graph, in accordance with an implementation;

FIG. 5 is an illustration of a graph to detect a source of an attack, in accordance with an implementation;

FIG. 6 is a method for back-tracing one or more DDoS Attacks, in accordance with an implementation;

FIG. 7A is a block diagram depicting an implementation of a network environment including a client device in communication with a server device, in accordance with an implementation;

FIG. 7B is a block diagram depicting a cloud computing environment including a client device in communication with cloud service providers, in accordance with an implementation; and

FIG. 7C is a block diagram depicting an implementation of a computing device that can be used in connection with the system depicted in FIG. 1, and the methods and processes depicted in FIGS. 2-6, in accordance with an implementation.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and make part of this disclosure.

Network attacks, such as DDoS attacks are launched daily across the internet, with some estimates as high as 30,000 DDoS attacks daily or 7% of all internet traffic. Traffic associated with the network attacks can be carried across multiple Internet Service Providers (ISPs), which consumes valuable networking resources. Having the ability to locate the origin of the network attacks, can make it possible to directly block the attacking devices. For example, a source ISP facilitating the network attacks can be notified and then stop the attacking devices. As another example, adjacent ISPs can put pressure on the originating ISP or block the traffic from the origination ISP. However, given that DDoS attacks are often spoofed, and thereby hide an actual origin of the network attacks, it is often difficult to identify the actual origin of the network attacks.

The techniques described herein may overcome the aforementioned technical deficiencies in identifying the actual origin of network attacks, especially when the origin of the network attacks are being concealed or masked by falsifying (e.g., spoofing) the source. A computer may do so by analyzing flow records, network records, or attack feedback reporting records to back-trace a network attack to an originating ISP or originating computing device. For example, the computer may execute an algorithm which uses attack feedback and routing data to recursively back-trace DDoS attacks to an originating device, even if the source of the attack is being spoofed.

The back-tracing of DDoS attack can (1) identify the origin of specific DDoS attack vectors by identifying the source ISP network(s), (2) group multiple attack vectors together, building an attack graph for all the attack vectors used in a specific DDoS attack, (3) group multiple DDoS attacks together to identify DDoS attack paths towards an ISP, and (4) gain a global perspective on how DDoS attacks traverse across the Internet.

When a DDoS attack is launched, the DDoS attack can be visible through an analysis of Netflow records or flow records. The flow records can include information, such as the source IP address, the destination IP addresses, source ports, destination ports, a protocol, and additional fields, such as the reporting device (router/switch), the source interface, the destination interface, a previous hop (e.g., PrevHop) IP address and a next hop (e.g., NextHop) IP address. The computer can combine this information, with internal peering information to determine a source Autonomous System Number (ASN) and a destination ASN for each traffic flow included in the flow records.

After a DDoS attack is detected, the computer can receive DDoS attack feedback, such as the source IP address, the destination IP address, timestamps, protocols, attack volume, attack direction (Inbound, Outbound), as well as information about the source ASN and the destination ASN. When a DDoS attack traverses the Internet, the DDoS attack can go through multiple ISPs. In instances where one or more ISPs provide feedback reports, the DDoS attack can be reported as it was seen by a local ISP.

The computer, using the feedback reports from multiple ISPs, can stitch together different feedback records to build a path of how the DDoS attack traversed the Internet (with the path starting at the destination and ending at the origin of the attack). The computer can utilize the destination IP address of the DDoS attacks (along with associated timestamps and attack characteristics) to back-trace network attacks even when the network attacks are spoofed attacks.

The back-tracing of DDoS attacks can provide several technical advantages and benefits. Some benefits can include (1) providing an expansion of how DDoS attacks flow across the internet, (2) identifying potentially malicious ISPs, (3) identifying ISPs that do not implement address validation (e.g., SAV), (4) identifying bullet-proof hosting providers, (5) gaining an understanding of various paths which are taken by DDoS attacks to understand effectiveness of DDoS interdiction and DDoS suppression, (6) allowing clients to automatically identify peering partners that are lacking basic DDoS security or do not seem concerned with DDoS attacks, and (7) providing enhanced visibility about network provider's ability to address DDoS attacks. Moreover, by back-tracing DDoS attacks to the source, network operations can be improved through throttling or bottlenecking network traffic that is associated with facilitating or forwarding a DDoS attack. The throttling or bottlenecking of the network traffic can improve network operations as data packets or communication sessions associated with the DDoS attacks can be dropped or otherwise interrupted to free up the network.

In some embodiments, as referred to herein, a flow record, flow records, or records may refer to or include one or more of (Net)flow records, feedback records, attack feedback reports, or other records forwarded by or otherwise provided by an ISP experiencing or detecting a network attack. As referred to herein, a source or origin may refer to an IP address which initiated establishment of a connection or transmission of a data packet on a network, in some embodiments. A destination may refer to an IP address which is a designated or identified recipient of a data packet or other network traffic, in some embodiments. A previous hop may refer to or include a previous, most recent, prior, or last network device that transmitted or otherwise forwarded a data packet, in some embodiments. A next hop may refer to or include a subsequent, an ensuing, or a following network device for which a data packet is set to be forwarded or otherwise transmitted to.

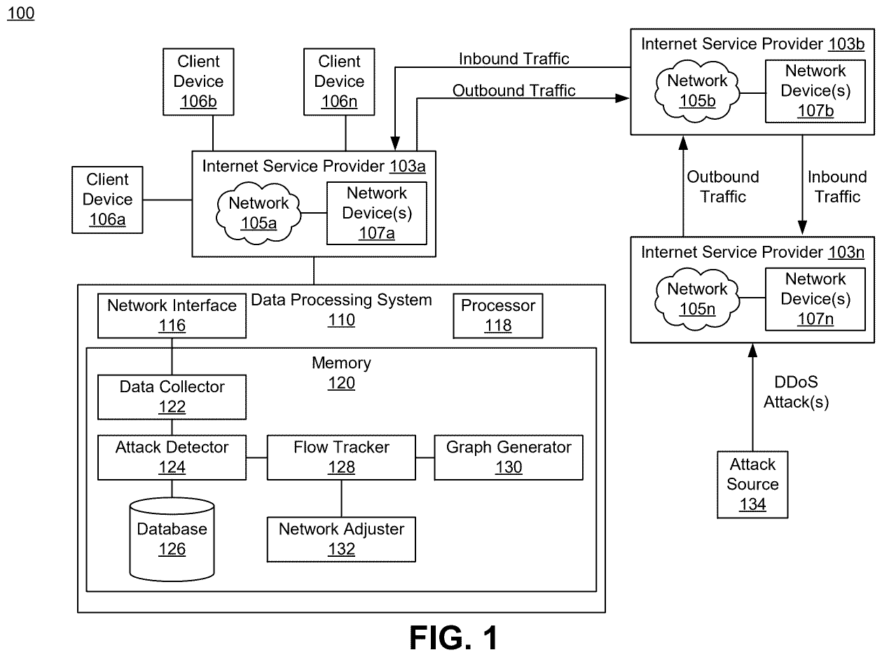

FIG. 1 is an illustration of a system 100 for back-tracing DDoS attacks, in accordance with an implementation. The system 100 may or may not operate autonomously. The system 100 may enable the back-tracing of DDoS attacks by analyzing flow records associated with the transmission or forwarding of data packets between Internet Service Providers (ISPs). In brief overview, the system 100 can include, access, or otherwise interface with one or more of a data processing system 110 (e.g., a probe, an inspection device), that receives and/or stores data packets (or corresponding flow records) transmitted by or received by one or more client devices (shown as client device 106a, client device 106b, and client device 106n in FIG. 1).

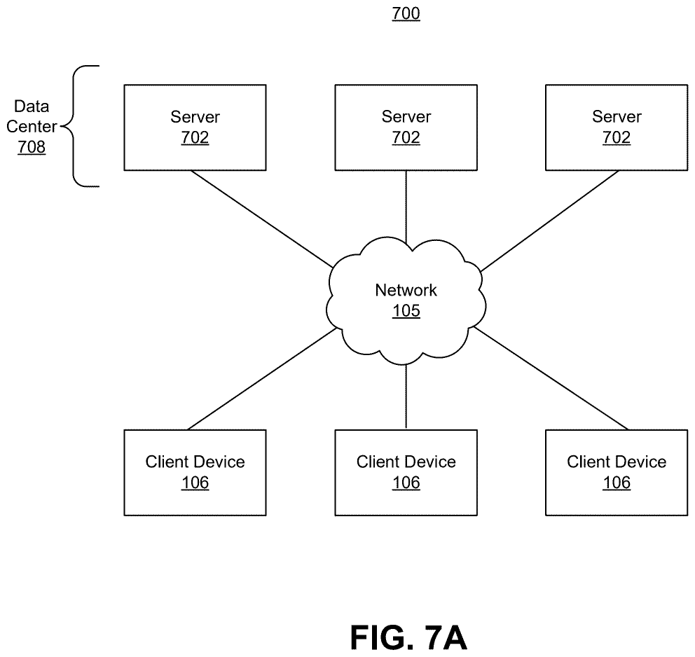

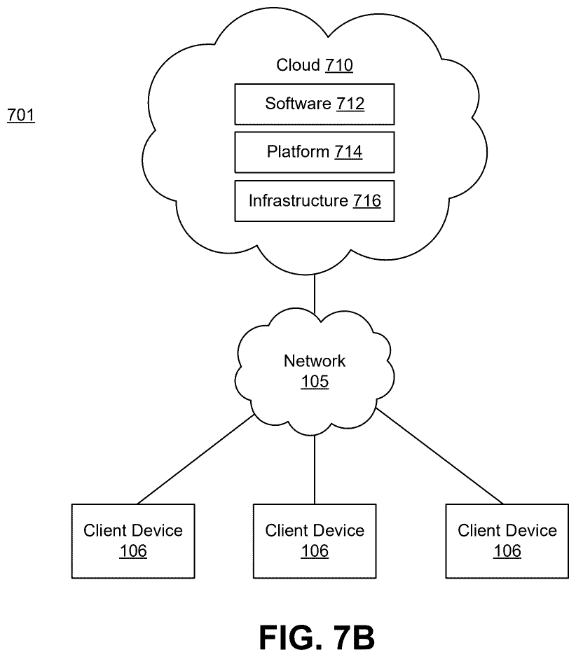

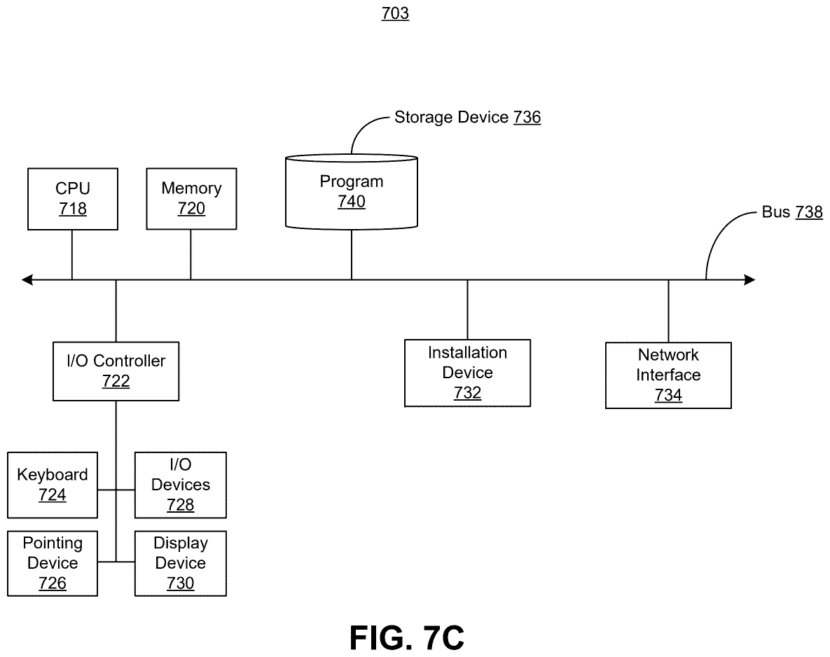

The client devices 106 can communicate with one or more Internet Service Providers (ISPs), shown as ISP 103a, ISP 103b, and ISP 103n in FIG. 1. The ISPs may refer to or include one or more Autonomous Systems that include corresponding Autonomous System Numbers (ASNs) and/or other identifiers. The ISP 103a, the ISP 103b, and the ISP 103n can each include a set of one or more servers 702, depicted in FIG. 7A, or a data center 708. The ISPs can include or otherwise provide one or more networks. For example, as shown in FIG. 1, the ISP 103a includes a network 105a, the ISP 103b includes a network 105b, and the ISP 103n includes a network 105n. The networks 105 may each be any type or form of network, such as a wired or wireless network and/or a synchronized or asynchronized network.

In some embodiments, the networks 105 may be accessible or facilitated by one or more network devices (shown as network device 107a, network device 107b, and network device 107n in FIG. 1). The network devices 107 may refer to or include one or more of routers, modems, bridges, gateways, hubs, network connectors, switches, repeaters, and other possible devices. In some embodiments, the ISPs 103 may include one or more peering relationships such that network traffic is forwarded or otherwise carried across the networks 105. For example, the ISP 103a may forward network traffic, from the client devices 106, to the ISP 103b. As another example, the ISP 103a may forward network traffic, from the ISP 103b, to the client devices 106.

The client devices 106 may be an example of a user equipment (UE) or another device that can access the networks 105. The client devices 106 can communicate with the ISPs 103 to access a service (e.g., a website, an application, etc.). The client devices 106 and the data processing system 110 can communicate or interface with one another via the networks 105 or directly.

Each of the ISPs 103, the client devices 106, and/or the data processing system 110 can include or utilize at least one processing unit or other logic device such as programmable logic array engine, or module configured to communicate with one another or other resources or databases. The components of the client devices 106, the ISPs 103, and/or the data processing system 110 can be separate components or a single component. In some embodiments, the data processing system 110 may be an intermediary device between the client devices 106 and ISPs 103. In some instances, the client devices 106, the ISPs 103, and the data processing system 110, or any combination thereof, may share at least some components or be the same device. The system 100 and its components can include hardware elements, such as one or more processors, logic devices, or circuits.

The client devices 106, the ISPs 103, and/or the data processing system 110 can include or execute on one or more processors or computing devices (e.g., computing device 703 depicted in FIG. 7C) and/or communicate via the network 105. The networks 105 can include computer networks such as the Internet, local, wide, metro, or other area networks, intranets, satellite networks, and other communication networks such as voice or data mobile telephone networks. Via the networks 105, the client devices 106 can access information resources such as web pages, web sites, domain names, or uniform resource locators that can be presented, output, rendered, or displayed on at least one computing device (e.g., the client devices 106), such as a laptop, desktop, tablet, personal digital assistant, smart phone, portable computers, or speaker. For example, via the network 105s, the client devices 106 can communicate with one or more servers for data (e.g., a communication session including requests from the client devices 106 and responses from the servers).

The system 100 can include one or more service providers that host different services or applications that can be accessed by computing devices, such as the client devices 106. The service providers can be hosted by a third-party cloud service provider via a virtual environment, in some embodiments. The service providers can be hosted in a public cloud, a co-location facility, or a private cloud, for example. The service providers can be hosted in a private data center, or on one or more physical servers, virtual machines, or containers of an entity or customer. The service providers may each be or include servers or computers configured to transmit or provide services across the networks 105 to the client devices 106.

In some embodiments, the service providers may transmit or provide such services upon receiving requests for the services from any of the client devices 106. The term “service” as used herein includes the supplying or providing of information over a network and is also referred to as a communications network service. Examples of services include 5G broadband services, any voice, data, or video service provided over a network, smart-grid network, digital telephone service, cellular service, Internet protocol television (IPTV), etc. The service may further include a SaaS application, such as a word processing application, spreadsheet application, presentation application, electronic message application, file storage system, productivity application, or any other SaaS application. The service providers can be hosted or refer to cloud 710 depicted in FIG. 7B.

The client devices 106 can establish communication sessions with the ISPs 103 to receive or otherwise transmit data packets across the networks 105. For example, a user associated with the client devices 106 may request a service. Responsive to the request, a service provider on the networks 105, that is associated with the service, may send requested data to the client devices 106 in a communication session. The client devices 106 may establish communication sessions with the service providers for any type of application or for any type of call.

The client devices 106 can be located or deployed at any geographic location in the network environment depicted in FIG. 1. The client devices 106 can be deployed, for example, at a geographic location where a typical user using the client devices 106 would seek to connect to a network (e.g., access a browser or another application that requires communication across a network). For example, a user can use a client devices 106 to access the Internet at home, as a passenger in a car, while riding a bus, in the park, at work, while eating at a restaurant, or in any other environment. The client devices 106 can be deployed at a separate site, such as an availability zone managed by a public cloud provider (e.g., a cloud 710 depicted in FIG. 7B). If the client devices 106 is deployed in a cloud 710, the client devices 106 can include or be referred to as a virtual client device or virtual machine. In the event the client devices 106 is deployed in a cloud 710, the packets exchanged between the client devices 106 and the service providers can still be retrieved by the data processing system 110 from the network 105. In some cases, the client devices 106 and/or the data processing system 110 can be deployed in the cloud 710 on the same computing host in an infrastructure 716 (described below with respect to FIG. 7B).

In some embodiments, one or more network attacks (e.g., DDoS attacks) may be facilitated or carried out across one or more of the networks 105. For example, as shown in FIG. 1, an attack source 134 may transmit or otherwise provide one or more DDoS attacks to the ISP 103n. In some embodiments, the ISP 103n or one or more devices (e.g., one or more client devices 106) connected to the ISP 103n may be the destination or the target of the DDoS attacks. For example, the attack source 134 may be attempting to disrupt the network 105n by targeting the ISP 103n. In some embodiments, the ISP 103n may simply be a transit provider or forwarding ISP. Stated otherwise, the ISP 103n may not be the destination or the target of the DDoS attack but simply is an intermediate ISP that forwards the DDoS attack to the target of the DDoS attack.

In some embodiments, one or more flow records may be generated, produced, generated, or otherwise created as data packets are transmitted across the networks 105. For example, one or more flow records may be generated (for corresponding data packets) which identify information, such as a next hop ASN (e.g., an ISP or an ASN to send the data packet to), a PrevHop (e.g., an ISP or an ASN that forwarded or provided the data packet), a reporting ASN (e.g., an ASN or ISP that received/forwarded the data packet), a destination IP address (e.g., the target of the attack), a destination ASN (e.g., an ASN or ISP for which the destination IP address belongs to), a source IP address. As another example, flow records (that are associated with network attacks) may include information, such as protocols (e.g., TCP, UDP, etc.) used to facilitate the network attack, attack direction (inbound, outbound, etc.), attack types, or attack packet per second (PPS), bits per second (BPS), or requests per second (RPS). In some embodiments, the ISPs 103 may store or otherwise maintain one or more flow records that are associated with inbound or outbound network traffic on a corresponding network (e.g., the networks 105). The ISPs 103 may provide or otherwise make the flow records accessible to the data processing system 110. For example, the data processing system 110 may provide one or more prompts or requests to the ISPs 103 (and/or the network devices 107) to obtain or otherwise receive the flow records.

While the DDoS attacks are shown, in FIG. 1, to originate at the attack source 134 (which is shown as being connected to the ISP 103n), this is for illustrative purposes only and is in no way limiting. For example, the attack source 134 may be connected to a different ISP (e.g., the ISP 103a or the ISP 103b). As another example, the attack source 134 may be an ISP itself that is connected to or in communication with one or more of the ISPs 103.

The data processing system 110 may comprise one or more processors that are configured to obtain network data packets from network 105 during a communication session between the client devices 106 and the ISPs 103. In some embodiments, the data processing system 110 may refer to and/or include a network monitoring device. The data processing system 110 may comprise a network interface 116, a processor 118, and/or memory 120. The data processing system 110 may communicate with any of the client devices 106, the ISPs 103, and/or service provides via the network interface 116. The processor 118 may be or include an ASIC, one or more FPGAs, a DSP, circuits containing one or more processing components, circuitry for supporting a microprocessor, a group of processing components, or other suitable electronic processing components. In some embodiments, the processor 118 may execute computer code or modules (e.g., executable code, object code, source code, script code, machine code, etc.) stored in the memory 120 to facilitate the operations described herein. The memory 120 may be any volatile or non-volatile computer-readable storage medium capable of storing data or computer code.

In some embodiments, the data processing system 110 may refer to or include one or more of a single instance which resides inside one or more ISPs, multiple instances discretely residing in respective ISPs, or a centralized instance which resides outside of or separate to the ISPs. For example, a first instance of the data processing system 110 may reside in the ISP 103a and a second instance of the data processing system 110 may reside in the ISP 103b. As another example, the data processing system 110 may be centralized and reside outside of each of the ISP 103a, the ISP 103b, and the ISP 103n.

The memory 120 may include one or more of a data collector 122, an attack detector 124, a database 126, a flow tracker 128, a graph generator 130, and/or a network adjuster 132. The data processing system 110 may further include other components, managers, handlers, etc. to perform the techniques as described herein. In brief overview, the components 122-132 may obtain a network data packet associated with a communication session between the client devices 106 and a network service provider (e.g., the ISPs 103, a service provider, etc.). The components 122-132 may determine whether the network data packet includes characteristics of being associated with a DDoS attack. For example, the components 122-132 may determine is the network data packet includes a payload to induce UDP flooding on the networks 105. As another example, the components 122-132 may determine if the network data packet includes a payload to flood the networks 105 with TCP Syn-Ack responses.

The data collector 122 may comprise programmable instructions that, upon execution, cause the processor 118 to monitor one or more data packet exchanges. For example, the data collector 122 may monitor data packet exchanges between the client devices 106 and the ISP 103a. As another example, the data collector 122 may monitor payloads which were carried or transmitted across the networks 105. In some embodiments, the data collector 122 may monitor encrypted data packet exchanges. For example, the data collector 122 may monitor encrypted data packet exchanges between one or more clients and a server. In some embodiments, a client may refer to a computer with a first IP address that initiates a session (e.g., a flow, communication, exchange, etc.) with a second computer having a second IP address.

The data collector 122 may obtain (e.g., receive, collect, etc.) data transmitted between the client devices 106 and the ISPs 103 as part of a communication session. For example, the client devices 106 may send a request, across the networks 105, for a service to a service provider. The data collector 122 may obtain or otherwise detect information associated with or sent in the request. The data collector 122 may store or otherwise maintain information or data (associated with network traffic) in the database 126). As another example, the data collector 122 may obtain data packets or underlying payload information and the data collector 122 may store information (which corresponds to the data packets or the payload) in the database 126.

The attack detector 124 may comprise programmable instructions that, upon execution, cause the processor 118 to evaluate a plurality of data packet exchanges. For example, the attack detector 124 may evaluate data packets or data packet exchanges obtained by the data collector 122. As another example, the attack detector 124 may retrieve, from one or more databases (e.g., the database 126), information obtained by the data collector 122. In some embodiments, the data packets, the data packet exchanges, and/or corresponding information may include IP addresses. For example, a given data packet exchange between a network device (e.g., the client devices 106) and a server (e.g., the service providers, the ISPs 103, etc.) may include or otherwise transmit an IP address of the client devices 106.

In some embodiments, the attack detector 124 may detect one or more network attacks (e.g., DDoS attacks, attacks on a network, etc.) being carried out on the networks 105. For example, the attack detector 124 may detect one or more data packets that are carrying out or facilitating the DDoS attacks for the attack source 134. As another example, the attack detector 124 may detect one or more data packets associated with TCP flooding. In some embodiments, the network attacks may be an attack on a computing device (e.g., the client devices 106) or an Autonomous System (e.g., the ISPs 103). For example, the client device 106a may have an IP address which is the destination IP address of the DDoS attacks. As another example, the ISP 103a may be the destination ISP of the DDoS attacks.

In some embodiments, the DDoS attack may be facilitated by the transmission of one or more data packets. For example, the DDoS attack may be forwarded (as or within one or more data packets) from the ISP 103n, to the ISP 103b, and then ultimately to the ISP 103a. The DDoS attacks may be transmitted directly to the target (e.g., a computing device, an Autonomous system, etc.) and/or transmitted via one or more intermediate devices. For example, the attack source 134 may connect directly to the ISP 103a to transmit the DDoS attack to the client device 106a. As another example, the attack source 134 may transmit, to the client device 106a, the DDoS attack by using the ISP 103n and the ISP 103b as intermediate or transit providers.

In some embodiments, the attack detector 124 may set one or more flags responsive to detection of the attack on the network. For example, the attack detector 124 may set flags to identify one or more data packets associated with carrying out a network attack. As another example, the attack detector 124 may store, using the flags as a key, one or more sets of information (associated with the data packets) in the database 126. In some embodiments, the attack detector 124 may set the flags to trigger or other cause the retrieval of flow records and/or network traffic records.

In some embodiments, the flow tracker 128 may prompt one or more network devices for flow records. For example, the flow tracker 128 may prompt the network devices 107 for one or more flow records associated with the IP address that is under attack. As another example, the flow tracker 128 may prompt the network devices 107 for flow records that list an ISP (whose network includes the IP address under attack) as a destination (e.g., a destination ISP, a destination Autonomous System, etc.). In some embodiments, the flow tracker 128 may prompt a network device, for the flow records, that is associated with the network 105 under attack. For example, the flow tracker 128 may prompt the network devices 107a for flow records based on the network 105a being the network that is under attack.

In some embodiments, the flow tracker 128 may store or otherwise maintain the flow records in the database 126. For example, the flow tracker 128 may store the flow records as one or more datasets. As another example, the flow tracker 128 may store the flow records as a data array. In some embodiments, the flow tracker 128 may filter or otherwise sort the flow records using one or more sets of information. For example, the flow tracker 128 may filter the flow records using the IP address that is under attack. Stated otherwise, the flow tracker 128 may retrieve, from the flow records, one or more subsets of flow records that list the IP address (that is under attack) as the destination IP address. The flow tracker 128 may filter the flow records such that the one or more subsets of flow records pertain to the destination or target of the network attack.

In some embodiments, the flow tracker 128 may back-trace network attacks against specific targets (e.g., computing devices, IP address, ISPs, Autonomous Systems, etc.). For example, the flow tracker 128 may back-trace an inbound spoofed UDP flooding DDoS attack that is being carried out against a client device with a given IP address. In some embodiments, the flow tracker 128 may back-trace the network attacks using the flow records obtained from the ISPs 103. For example, the flow tracker 128 may identify one or more flow records using one or more constraints, such as reporting ASN, next hop ASN, previous hop ASN, destination IP address, destination ASN, attack direction, protocols used in network attack, network attack type, attack BPS, and/or attack PPS. As another example, the flow tracker 128 may utilize physical links, communication channels, or Media Access Control (MAC) addresses to back-trace network attacks. The flow tracker 128 may utilize information, such as anomalous peaks or other non-falsifiable information (e.g., because they must exist (a) to transfer the data, and (b) to complete the attack) to assist in back-tracing the network attacks.

In some embodiments, the flow tracker 128 may utilize inbound flow records and/or outbound flow records. For example, the flow tracker 128 may utilize outbound flow records to identify next hop ASNs. Stated otherwise, flow records associated with network traffic from (e.g., outbound) the ISP 103b may be used to identify next hop ASNs. As another example, the flow tracker 128 may utilize inbound flow records to identify previous hop ASNs. Stated otherwise, flow records associated with network received by (e.g., inbound) by the ISP 103a may be used to identify previous hop ASNs. In some embodiments, outbound and/or inbound network traffic may be defined relative to a reporting ASN. For example, network traffic received by a given ASN may be referred to as inbound network traffic. As another example, network traffic that is transmitted to a given ASN may refer to or include outbound network traffic.

In some embodiments, the graph generator 130 may generate one or more graphs or nodes thereof. For example, the graph generator 130 may generate a graph to back-trace a network attack on a computing device. As another example, the graph generator 130 may add or otherwise generate one or more nodes for the graph. In some embodiments, graph generator 130 may generate or otherwise create the graph responsive to creation of a first node (e.g., an initial node, a root node, etc.). The first node may refer to or represent an ISP, an ASN, or an IP address that is under attack and/or a target of the graph. Stated otherwise, the first node may represent an end or destination of a network attack that is to be back-traced.

In some embodiments, the graph generator 130 may generate the first node using the flow records obtained by the flow tracker 128. For example, the graph generator 130 may retrieve, from the database 126, one or more flow records which include one or more of the following: (1) contains destination IP address as the attack target, (2) has the destination ASN as the attack destination, (3), has the attack direction equal to inbound or outbound, (4) contains a protocol which matches one or more attack protocols (e.g., UDP, TCP, HTTP, HTTPS, etc.), (5), contains an attack type which matches one or more attack types (e.g., misuse, flooding, etc.), and/or (6) includes an attack BPS or attack PPS that is smaller than or equal to a given threshold. Upon retrieval of the flow records using one or more of the variables listed above, the graph generator 130 may possess flow records, for the ISP having the IP address under attack. In some embodiments, the graph generator 130 may generate the first nodes to represent the target of the attack (e.g., an IP address, an ASN, an ISP, etc.). For example, the graph generator 130 may include an identifier of the target of the attack within the first node. Stated otherwise, the first node may include a label of the target of the attack.

In some embodiments, the graph generator 130 may identify one or more intermediate or transmit ISPs using the flow records. For example, the graph generator 130 may identify one or more autonomous systems that forwarded the network attack to the target of the network attack. As another example, the graph generator 130 may identify one or more sub-reporting ASNs. In some embodiments, the graph generator 130 may identify the intermediate ASNs by identifying, from the flow records, one or more flow records which list the destination ASN as the next hop ASN. For example, the graph generator 130 may filter the flow records to identify one or more flow records that have the ISP under attack listed as the destination ISP.

The graph generator 130 may identify the transmit ISPs based on identifiers associated with the sub-reporting ISP (e.g., ISPs listed as the previous ISP). In some embodiments, the graph generator 130 may generate or otherwise add one or more nodes, to the graph, which indicate that the network attack was forwarded by the intermediate ISPs. For example, one or more nodes (e.g., one or more second nodes) may be added which include an identifier of the intermediate ISP. The one or more nodes may be connected, via one or more edges, to the first node and/or the initial node (e.g., root node). In some embodiments, the edges may indicate that the first node is the next hop ISN and/or the next hop ASN.

In some embodiments, the graph generator 130 may expand or build up the graph using flow records associated with the intermediate ISPs. For example, the graph generator 130 may retrieve flow records from one or more network devices of the intermediate ISPs. The graph generator 130 may filter the flow records using the IP address of the target of the attack as well as the identifier of the intermediate ISPs. For example, the graph generator 130 may obtain, from the database 126, flow records which list (1) the target of the network attack as the destination IP address and (2) the intermediate ISP as the next hop ISP.

In some embodiments, the graph generator 130 may identify one or more subsequent autonomous systems (e.g., third autonomous systems, third ISPs, third ASNs, etc.) based on the flow records for the intermediate ISPs. For example, the graph generator 130 may identify, from the flow records, one or more ASNs that are listed as the previous hop ASN. In some embodiments, the graph generator 130 may generate one or more third or subsequent nodes to the graphs. For example, the graph generator 130 may generate nodes to represent ISPs that forwarded the network attack to the intermediate ISPs. In some embodiments, the graph generator 130 may connect the second nodes with the one or more third nodes via one or more edges which list the intermediate ISP as the next hop ISP.

In some embodiments, the graph generator 130 may identify or otherwise detect a source of one or more network attacks. For example, the graph generator 130 may back-trace or otherwise traverse the graph to identify an end node or source node that identifies the source (e.g., the real source or actual source node) of an attack. As another example, the graph generator 130 may travel, via the edges, between nodes to identify a node that represents an instantiation or start of the network attack. In some embodiments, the graph generator 130 may set one or more flags to identify a source autonomous system (e.g., a system that initially carried out or forwarded the network attack). For example, the graph generator 130 may set one or more flags to identify the ISP 103n as being a source ISP that represents the initial forwarding of the network attack. The graph generator 130 may provide or otherwise indicate the flags to the network adjuster 132.

In some embodiments, the network adjuster 132 may store one or more associations. For example, the network adjuster 132 may store the flags (set by the graph generator 130) in the database 126. As another example, the network adjuster 132 may store, in the graph, an association between a source of a network attack and a target of the network attack. In some embodiments, the network adjuster 132 may take one or more actions to address the network attack. For example, the network adjuster 132 may cause at least one of the ISPs 103 to throttle or otherwise drop one or more data packets. The network adjuster 132 may cause the ISPs 103 to drop data packets associated with the transmission of the network attack and/or data packets identified as being transmitted by the source of the network attack. In some embodiments, the network adjuster 132 may adjust the networks 105 by preventing the forwarding or subsequent transmission of data packets which originated at the source of the network attack.

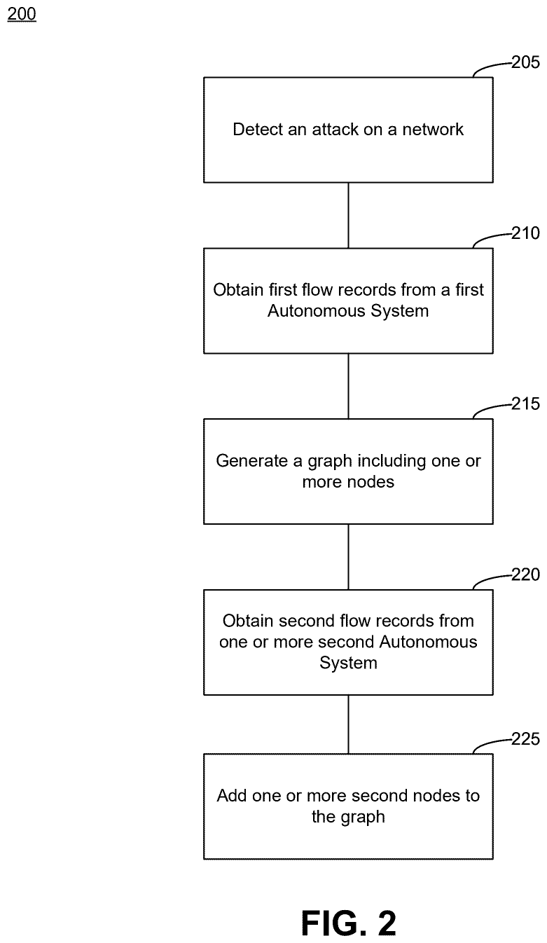

FIG. 2 is an illustration of a flow diagram of a process 200 to generate a graph for back-tracing one or more DDoS attacks, in accordance with an implementation. The process 200 can be performed by a data processing system (the data processing system 110, shown and described with reference to FIG. 1). The process 200 may include more or fewer operations and the operations may be performed in any order. Performance of the process 200 may enable the data processing system to generate one or more graphs to back-trace (e.g., identify or detect a source of a network attack).

At operation 205, the data processing system detects an attack on a network. For example, the data processing system may detect a TCP flooding attack on one of the networks 105. As another example, the data processing system may detect one or more attack types within data packets transmitted by the ISP 103b. In some embodiments, the data processing system may identify a destination (e.g., a target) of the attack. For example, the data processing system may identify an IP address of the network 105a that is indicated as the destination IP address in one or more data packets carrying out the attack. As another example, the data processing system may identify an Autonomous System that is listed as the destination Autonomous System.

At operation 210, the data processing system obtains first flow records. For example, the data processing system may obtain flow records from the Autonomous System (e.g., a first autonomous system) that is listed as the destination Autonomous System. The data processing system may obtain the flow records by prompting or otherwise requesting flow records from a network device of the Autonomous System. In some embodiments, the flow records may refer to or include the various flow records and/or information included in the various flow records as described herein. For example, the flow records may include or represent inbound or outbound network traffic. As another example, the flow records may indicate, for a given data packet, information, such as a destination IP address, a previous hop ASN, a destination ASN. As another example, the flow records may include information, such as PPS, BPS, or RPS.

At operation 215, the data processing system generates a graph including one or more nodes. For example, the data processing system may generate a graph that includes a first node or an initial or root node to represent an IP address subject to a network attack. As another example, the data processing system may generate an initial node to represent a destination ASN. In some embodiments, the data processing system may generate the initial or root nodes using the flow records obtained in operation 210. For example, the data processing system may retrieve, from a database, one or more of the flow records which (1) list the IP address as the destination IP address and (2) include one or more attack types. As another example, the data processing system may retrieve one or more of the flow records which (1) list the ASN as the destination ASN and (2) include attack BPS or attack PPS below a given threshold.

At operation 220, the data processing system obtains second flow records. For example, the data processing system may obtain flow records from one or more second Autonomous Systems (e.g., transit providers, intermediate devices, etc.) which were listed as the previous hop ASN in the first flow records. The data processing system may identify the previous hop ASN by evaluating one or more flow records of the first flow records that list the target ASN as a next hop ASN. As another example, the data processing system may obtain the flow records by querying or otherwise searching a database to obtain flow records associated with inbound traffic into the target ASN.

At operation 225, the data processing system adds one or more second nodes to the graph. For example, the data processing system may add one or more nodes (e.g., second nodes) to the graph that represent the one or more second Autonomous Systems. As another example, the data processing system may add one or more nodes to identify which ISPs transmitted or otherwise forwards the network attack to the target ISP.

In some embodiments, the data processing system may repeat or otherwise reproduce one or more operations of the process 200 to build up or expand the graph. For example, the data processing system may repeat operation 220 such that the data processing system obtains flow records that correspond to subsequent Autonomous Systems. Stated otherwise, the data processing system may continue to identify Autonomous Systems by evaluating flow records, for a given Autonomous System, to identify a previous hop ASN. Once a previous hop ASN (e.g., a new ASN or preceding ASN which is not reflected or represented in the graph), the data processing system may obtain corresponding flow records to continue to back-trace a network attack. The data processing system may continue this process (e.g., obtain flow records, identify a previous ASN, etc.) until a given amount of time elapses or until the data processing system determines that the network attack cannot be further back-traced. Potential blind spots or absent nodes may occur based on a path of data packets between autonomous systems, however the blind spots can be addressed by discovering or adding additional nodes to the graph.

In some embodiments, the data processing system may continue to build up or expand the graph by adding one or more nodes or edges to the graph. For example, the data processing system may add nodes, to the graph, responsive to identification of a previously unrepresented ASN in the graph. In some embodiments, the data processing system may determine that one or more autonomous systems and/or ISPs are not listed as a next hop. Stated otherwise, the data processing system may determine that one or more data packets originated at the ISP (e.g., is the source) and therefore there is no previous hop ISP. In some embodiments, the data processing system may prevent subsequent generation of nodes. For example, the data processing system may halt or stop generating nodes to attach to the ISP (given the ISP being the source) as there are no additional ISPs to back-trace network traffic to.

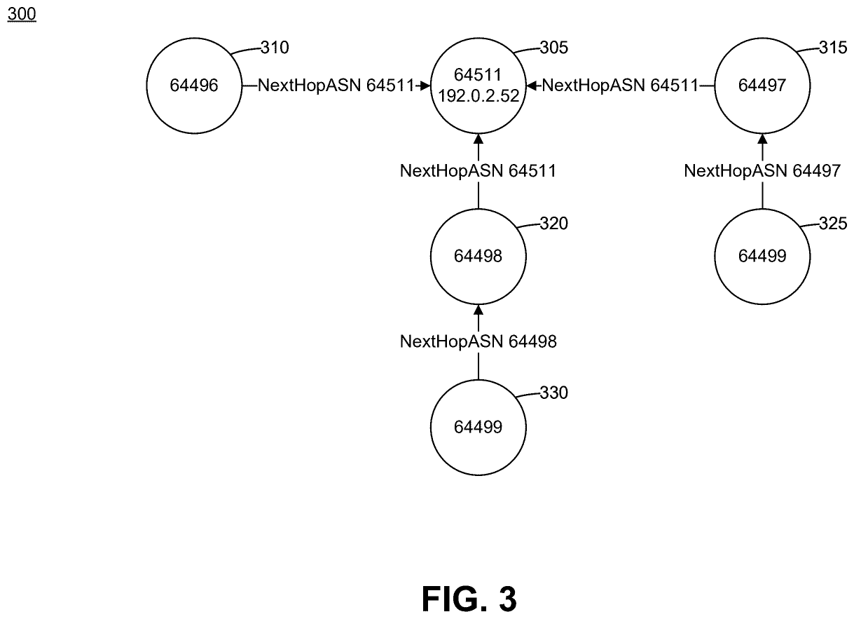

FIG. 3 is an illustration of a graph 300 for back-tracing one or more DDoS attacks, in accordance with an implementation. In some embodiments, the data processing system 110 and/or one or more various processing systems described herein may generate, produce, or otherwise create the graph 300. In some embodiments, the graph 300 may include one or more nodes which represent corresponding ISPs or Autonomous Systems. For example, as shown in FIG. 3, the graph 300 includes a node 305, a node 310, a node 315, a node 320, a node 325, and a node 330. In some embodiments, the nodes of the graph 300 may be connected via one or more edges (shown as arrows in FIG. 3). The edge may identify or otherwise indicate a next hop ASN. For example, as shown in FIG. 3, the edge that connects the node 310 with the node 305 is shown with the label NextHop ASN 64511, which indicates that ASN 64511 (which is represented by the node 305) is the next hop ASN relative to ASN 64496 (which is represented by the node 310) for the DDoS attacks. While FIG. 3 may include nodes that represent or indicate ASN or IP addresses, this is for illustrative purposes and is in no way limiting. For example, the graph 300 may include additional or different ASNs relative to the ASN illustrated in FIG. 3.

The graph 300, as shown in FIG. 3, represents an example of the node 305 being a first node or a root node. Stated otherwise, the node 305 represents a target or destination of a network attack. The node 305 includes a label which identifies the target ASN (e.g., destination ASN, destination ISP, etc.) and the target IP address (e.g., destination IP address, etc.). In some embodiments, the subsequent or additional nodes (e.g., node 310, node 315, node 320, node 325, node 330, etc.) may be generated using one or more flow records. For example, the node 310 and the node 315 may be generated using flow records associated with the node 305 (e.g., ASN 64511, IP address 192.0.2.52, etc.).

In some embodiments, the data processing system 110 may obtain, responsive to detection of an attack on the target IP address, flow records associated with the ISP or ASN that is hosting a network which the target IP address is included in. For example, the data processing system 110 may obtain flow records for the ISP represented by the node 305. In some embodiments, the data processing system 110 may identify one or more autonomous system or ISPs (for the subsequent or additional nodes) using the flow records. For example, the data processing system 110 may identify ASN 64496 (represented by the node 310) using the flow records for ASN 64511 (represented by the node 305). The flow records for the ASN 64511 may indicate that the ASN 64511 is a next hop ASN for which one or more data packets were forwarded by the ASN 64496.

In some embodiments, once a node is added to or generated for the graph 300, the data processing system 110 may obtain flow records corresponding to an ASN or ISP represented by the node. For example, upon generation of the node 320 (which represents ASN 64498), the data processing system 110 may obtain flow records from the ASN 64498. The data processing system 110 may expand or build up the graph 300 using the flow records from the ASN 64498. For example, the data processing system 110 may identify, from the flow records from the ASN 64498, the ASN 64499 (which is represented by the node 330). As another example, the data processing system 110 may identify, from flow records from the ASN 64497 (which is represented by the node 315), the ASN 64499 (which is represented by the node 325).

In some embodiments, the data processing system 110 may continue to build up the graph by adding nodes to the graph using flow records obtained from a next hop ASN. For example, the data processing system 110 may (1) identify ASNs listed as a next hop ASN and (2) prompt the identified ASNs for flow records to identify additional or subsequent ASNs. In some embodiments, the data processing system 110 may traverse the graph to back-trace one or more network attacks. For example, the data processing system 110 may start at the node 305 (e.g., the first node, the root node, the target of an attack, etc.) and travel, via one or more edges, to the node 310, the node 315, or the node 320. Once at the node 310, the node 315, or the node 320, the data processing system 110 may travel, via one or more second edges, to the node 330 or the node 325. While ASN 64496 (which is represented by the node 310) is shown as not being a NextHop ASN, this is for illustrative purposes only and is in no way limited.

### Identifying Nodes Having no Direct Connections

In some instances, the data processing system 110 may detect one or more gaps or voids in the graph 300. For example, the data processing system 110 may detect that one or more ASNs or ISPs are not providing flow records. Stated otherwise, the data processing system 110 is unable to back-trace one or more nodes given that further flow records are not being provided. In some embodiments, the lack of information (e.g., the flow records) may be based on the data processing system 110 not having a relationship or an agreement with a reporting ASN and/or sub-reporting ASN. Stated otherwise, the reporting ASN may not have agreed to share flow records that corresponded to inbound network traffic or outbound network traffic. As another example, the network attack (while delivered across or provided to the reporting ASN) may have been transmitted as multiple data packets, which aggregated after or subsequent to the reporting ASN. Additionally, or alternatively, the data processing system 110 may utilize information, such as public routing information (e.g., routing tables, routing protocols, public directories, etc.) to identify links or connections between nodes.

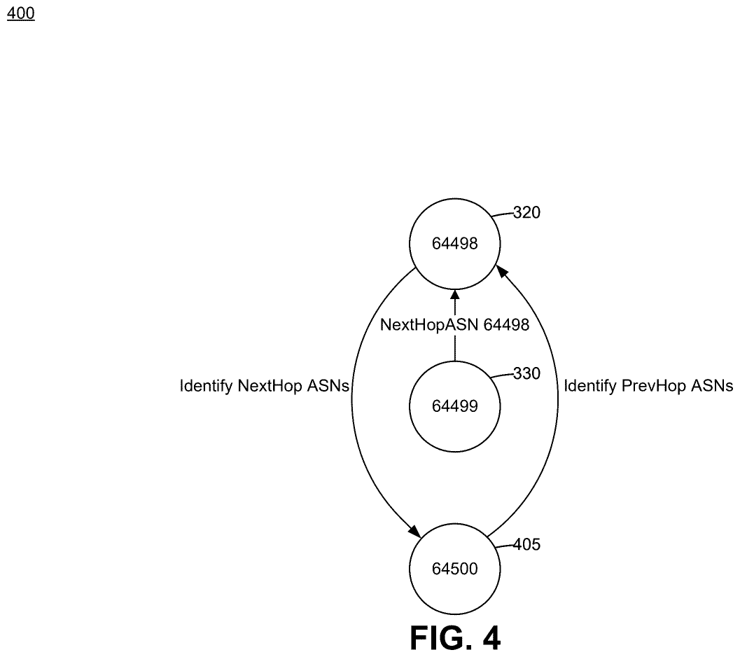

FIG. 4 is an illustration of one or more disconnected nodes of a graph 400, in accordance with an implementation. In some embodiments, the graph 400 and/or the nodes thereof may refer to or include the graph 300 or one or more nodes of the graph 300. For example, as shown in FIG. 4, the graph 400 includes the node 320 and the node 330. The graph 400 is shown to have a gap (e.g., no edge) between the node 330 and a node 405. In some embodiments, the node 330 and/or the node 405 may refer to or include a disconnected node as there is not an edge connecting the node 330 with the node 405.

In some embodiments, the graph 400 may include one or more disconnected nodes a result of one or more ASNs or ISPs not reporting flow records. For example, the gap between the node 330 and the node 405 may result from the ASN 64499 (which is represented by the node 330) not providing flow records for inbound network traffic (e.g., network traffic transmitted to or received by the ASN 64499). In some embodiments, the gap of the graph 400 may result from the data processing system 110 being unable (based on flow records of the ASN 64499) being able to identify a previous ASN.

In some embodiments, the data processing system 110 may resolve the gaps of the graph 400. For example, the data processing system 110 may retrieve one or more tables from a data source (e.g., the database 126, a remote server, a remote service, etc.). The tables may refer to or include Internet routing tables that include or indicate peering relationships between ASNs and/or ISPs. In some embodiments, the data processing system 110 may, using the tables, identify one or more ASNs or ISPs that communicate with a non-reporting ASN and/or non-reporting ISP. For example, the data processing system 110 may identify ASN 64500 (which is represented by the node 405) using the tables.

In some embodiments, the data processing system 110 may prompt the ASN 64500 for one or more flow records which indicate the ASN 64499 as the next hop ASN. The data processing system 110 may filter or other search the flow records, of the ASN 64500, for one or more flow records associated with transmission of the network attack. In some embodiments, the data processing system 110 may add, to the graph 400, an edge to connect the node 405 with the node 330. For example, the data processing system 110 may add the edge responsive to detecting, from the flow records of the ASN 64500, that the network attack was facilitated by transmitted one or more data packets to the ASN 64499, which was then forwarded to the ASN 64498

### Identify Attack Sources Using Graph Nodes

In some instances, upon identification or creation of the nodes for the graph 300 and/or one or more additional graphs, the data processing system 110 may identify a source of the network attack. For example, the data processing system 110 may traverse the graph 300 to identify one or more end nodes or leaf nodes (e.g., nodes that are not followed by one or more additional nodes). As another example, the data processing system 110 may identify the source of a network attack by identifying an ASN or an ISP based on a corresponding node of the graph 300 indicated that the ASN or the ISP is not a next hop (e.g., there is not an additional ISP or an additional ASN that is forwarding the network attack).

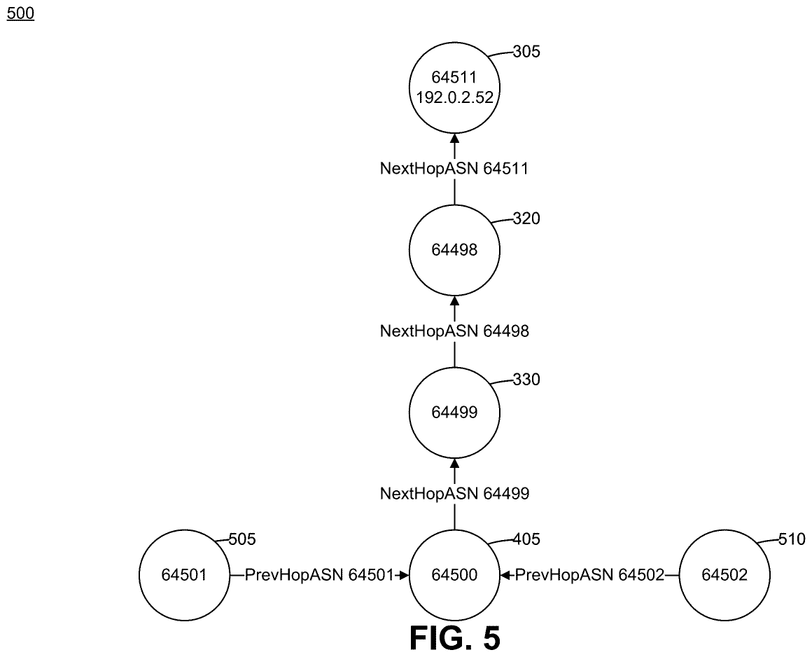

FIG. 5 is an illustration of a graph 500 to detect a source of an attack, in accordance with an implementation. In some embodiments, the data processing system 110 may evaluate flow records associated with the leaf nodes or the end nodes. For example, the data processing system 110 may evaluate flow records associated with outbound network traffic (e.g., one or more data packets leaving or being transmitted by an ISP). In some instances, the data processing system 110 may evaluate flow records associated with an end node or a leaf node. For example, the node 405 may represent an end node or a leaf node. In some embodiments, the graph 500 may refer to or include the graph 300 having been completed or filled-out by adding an edge between the node 330 and the node 405.

In some embodiments, the data processing system 110 may identify a source of the attack by evaluating flow records associated with the ASN 64500 (which is represented by the node 405). For example, the data processing system 110 may execute one or more truth statements, on the flow records, to identify a source of the attack. In some embodiments, the truth statements may include (1) setting the reporting ASN equal to the ASN represented by the leaf node, (2) setting previous hop ASN not equal to reporting ASN, (3) destination IP address is equal to the target IP address, (4) the attack direction is equal to outbound, (5) the protocol includes one or more attack protocols, (6) includes an attack type that matches the attack type, and (7) the BPS and/or the PPS is less than or equal to attack BPS and/or the attack PPS.

If execution of the truth statements, by the data processing system 110, returns one or more hits (e.g., network traffic that matches the truth statements recited above), then an underlying ASN (e.g., an ASN indicated in the flow records as a previous hop ASN) is the source of the network attack. In other instances, if execution of the truth statements, by the data processing system 110, returns no hits, then the ASN represented by the leaf node is the source of the network attack.

In some instances, the data processing system 110 may add one or more additional nodes responsive to execution of the truth statements returning one or more hits. For example, the data processing system 110 may add one or more nodes to the graph 500 to represent one or more previous hop ASNs which were determined to be the source of the network attack. As shown in FIG. 5, the graph 500 includes a node 505 and a node 510. The node 505 is shown to represent ASN 64501 (which is shown as a previous hop ASN) and the node 510 is shown to represent ASN 64502 (which is shown as a previous hop ASN). In some embodiments, the ASN 64501 and/or the ASN 64502 may be the source of the network attack. For example, the ASN 64501 may contain the attack source 134.

### Visualization

In some embodiments, the data processing system 110 may utilize a main graph (e.g., the graph 300, the graph 400, the graph 500, etc.) and/or one or more sub-graphs (e.g., portions) to create a visualization (e.g., a digital representation or digital illustration) where the main graph identifies one or more paths or hops that were taken during the transmission of the network attack. Additionally, if the graph includes one or more isolated or standalone nodes (e.g., unconnected), these nodes can be interpretated as being positioned between one or more nodes.

In some embodiments, the algorithms, methods, systems, or processes described herein may include DDoS Reflection/Amplification attacks. For example, the data processing system 110 may utilize one or more graphs to identify DDoS Reflection/Amplification attacks where the source IP address is spoofed to launch Reflected DDoS attacks against the spoofed source IP address. In some embodiments, the Reflected DDoS attacks may create spoofed traffic based on receiving spoofed attack initiation traffic. The data processing system can identify the spoofed source IP address using source IP address instead of destination IP address when filtering the flow records described herein.

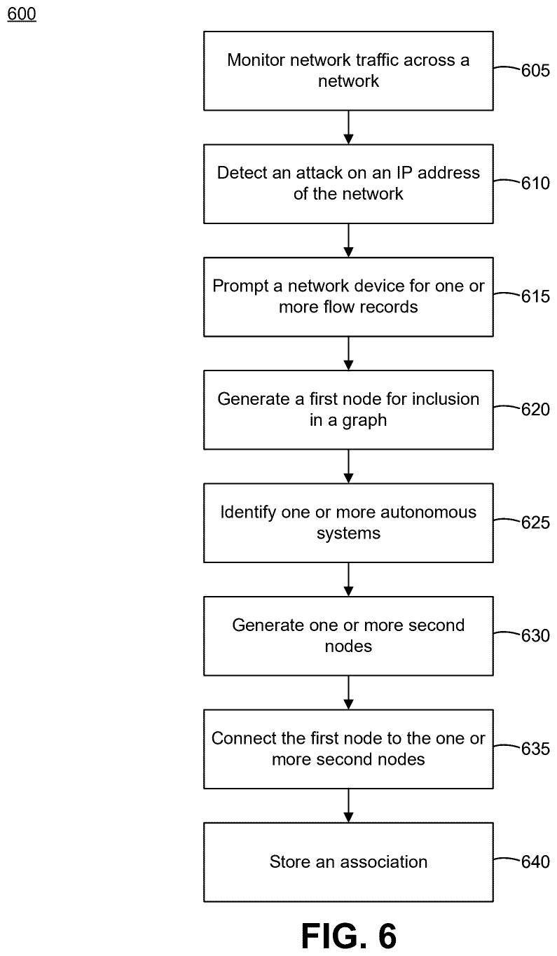

FIG. 6 is a method 600 for back-tracing one or more DDoS Attacks, in accordance with an implementation. The method 600 can be performed by one or more systems, components, or modules depicted in FIGS. 1 and/or 7A-7C, including, for example, a data processing system or service of a cloud service provider system. The method 600 may include more or fewer operations and the operations may be performed in any order. Performance of the method 600 may enable the data processing system to back-trace one or more network attacks and/or attacks on a network.

At operation 605, the data processing system monitors network traffic across a network. For example, the data processing system may monitor an exchange of one or more data packets across a network. The network may be hosted by or provided by an Autonomous System and/or an ISP. The network traffic may include one or more data packets which are being forwarded from a second network. For example, the network traffic may include one or more data packets which originated on a different network.

At operation 610, the data processing system detects an attack on an IP address of the network. For example, the data processing system may detect a TCP flooding attack on a computing device (e.g., an IP address) connected to the network. The data processing system may detect the attack based on an evaluation of one or more data packets transmitted across the network. For example, the data processing system may identify a set of data packets having BPS values or PPS values that exceeds and/or violates a threshold. In some embodiments, the data processing system may determine an underlying ISP or Autonomous system (e.g., a system hosting, providing, or supporting the network experiencing the attack).

At operation 615, the data processing system prompts a network device for one or more first flow records. For example, the data processing system may prompt a router or bridge device associated with the underlying ISP that includes an IP address experiencing a network attack. In some embodiments, the data processing system may prompt the network device for flow records that correspond to inbound network traffic and/or outbound network traffic. For example, the data processing system may prompt a router for flow records that correspond to one or more data packets transmitted to the ISP.

At operation 620, the data processing system generates a first node for inclusion in a graph. For example, the data processing system may generate a note for a directed acyclic graph (DAG). The data processing system may generate a node which represents at least one of an ASN, an ISP, or an IP address that is experiencing and/or the target of a network attack. The node may represent or indicate an end target or final destination for the network attack. In some embodiments, the data processing system may back-trace the network attack by retracing the steps or network hops taking by one or more data packets.

At operation 625, the data processing system identifies one or more autonomous systems. For example, the data processing system may identify one or more autonomous systems which are listed as and/or indicated as a previous hop within the flow records obtained in operation 620. As another example, the data processing system may identify, from the inbound network traffic, one or more autonomous systems that forwarded or otherwise transmitted one or more data packets to the autonomous system which is hosting the IP address that is under attack.

In some embodiments, the data processing system may filter or otherwise restrict the flow records to one or more flow records which list the IP address (that is under attack) as the destination IP address and/or which lists the autonomous system (hosting the IP address) as the destination autonomous system. Stated otherwise, the data processing system may filter the flow records to include one or more flow records that represent data packets which terminated and/or concluded at the autonomous system hosting the IP address.

At operation 630, the data processing system generates one or more second nodes. For example, the data processing system may generate one or more nodes to represent the autonomous systems identified in operation 625. As another example, the data processing system may generate nodes for inclusion in the graph which includes the node generated in operation 620. In some embodiments, the data processing system may generate the nodes to represent at least one of an ISP or an ASN that forwarded or transmitted one or more data packets (which were part of the attack) to the autonomous system that is hosting the IP address experiencing the attack.

At operation 635, the data processing system connects the first node to the one or more second nodes. For example, the data processing system may connect, via one or more edges, the node (generated in operation 620) to the one or more nodes (generated in operation 630). The data processing system may connect the nodes to indicate or otherwise identify a network flow. For example, the edges may include arrows or other directional elements which indicate a flow or directionality of data packets between autonomous systems and/or ISP. As another example, the edges may include an indication that a first ASN is a next hop ASN for one or more data packets.

At operation 640, the data processing system stores an association. For example, the data processing system may store an association between one or more autonomous systems in a database. As another example, the data processing system may store an association which indicates a source (e.g., a source autonomous system) which is ultimately responsible for the creation or instantiation of the network attack. Stated otherwise, the data processing system may store an association which tracks or identifies that the network attack started at a first ASN and then traveled (via one or more second ASNs) to the target IP address.

FIG. 7A depicts an example network environment that can be used in connection with the methods and systems described herein. In brief overview, the network environment 700 includes one or more client devices 106 (also generally referred to as clients, client node, client machines, client computers, client computing devices, endpoints, or endpoint nodes) in communication with one or more servers 702 (also generally referred to as servers, nodes, or remote machine) via one or more networks 105. In some embodiments, the client device 106 has the capacity to function as both a client node seeking access to resources provided by a server and as a server providing access to hosted resources for other client devices 106.

Although FIG. 7A shows the network 105 between the client devices 106 and the servers 702, the client devices 106 and the servers 702 can be on the same network 105. In embodiments, there are multiple networks 105 between the client devices 106 and the servers 702. The network 105 can include multiple networks such as a private network and a public network. The network 105 can include multiple private networks.

The network 105 can be connected via wired or wireless links. Wired links can include Digital Subscriber Line (DSL), coaxial cable lines, or optical fiber lines. The wireless links can include BLUETOOTH, Wi-Fi, Worldwide Interoperability for Microwave Access (WiMAX), an infrared channel or satellite band. The wireless links can also include any cellular network standards used to communicate among mobile devices, including standards that qualify as 1G, 2G, 3G, 4G, 5G or other standards. The network standards can qualify as one or more generation of mobile telecommunication standards by fulfilling a specification or standards such as the specifications maintained by International Telecommunication Union. Examples of cellular network standards include AMPS, GSM, GPRS, UMTS, LTE, LTE Advanced, Mobile WiMAX, and WiMAX-Advanced. Cellular network standards can use various channel access methods e.g., FDMA, TDMA, CDMA, or SDMA. In some embodiments, different types of data can be transmitted via different links and standards. In other embodiments, the same types of data can be transmitted via different links and standards.

The network 105 can be any type and/or form of network. The geographical scope of the network 105 can vary widely and the network 105 can be a body area network (BAN), a personal area network (PAN), a local-area network (LAN), e.g., Intranet, a metropolitan area network (MAN), a wide area network (WAN), or the Internet. The topology of the network 105 can be of any form and can include, e.g., any of the following: point-to-point, bus, star, ring, mesh, or tree. The network 105 can be an overlay network which is virtual and sits on top of one or more layers of other networks 105. The network 105 can be of any such network topology as known to those ordinarily skilled in the art capable of supporting the operations described herein. The network 105 can utilize different techniques and layers or stacks of protocols, including, e.g., the Ethernet protocol or the internet protocol suite (TCP/IP). The TCP/IP internet protocol suite can include application layer, transport layer, internet layer (including, e.g., IPv6), or the link layer. The network 105 can be a type of a broadcast network, a telecommunications network, a data communication network, or a computer network.

The network environment 700 can include multiple, logically grouped servers 702. The logical group of servers can be referred to as a data center 708 (or server farm or machine farm). In embodiments, the servers 702 can be geographically dispersed. The data center 708 can be administered as a single entity or different entities. The data center 708 can include multiple data centers 708 that can be geographically dispersed. The servers 702 within each data center 708 can be homogeneous or heterogeneous (e.g., one or more of the servers 702 or machines can operate according to one type of operating system platform (e.g., WINDOWS NT, manufactured by Microsoft Corp. of Redmond, Washington), while one or more of the other servers 702 can operate on according to another type of operating system platform (e.g., Unix, Linux, or Mac OS X)). The servers 702 of each data center 708 do not need to be physically proximate to another server 702 in the same machine farm. Thus, the group of servers 702 logically grouped as the data center 708 can be interconnected using a network. Management of the data center 708 can be de-centralized. For example, one or more servers 702 can comprise components, subsystems, and modules to support one or more management services for the data center 708.

Server 702 can be a file server, application server, web server, proxy server, appliance, network appliance, gateway, gateway server, virtualization server, deployment server, SSL VPN server, or firewall. In embodiments, the server 702 can be referred to as a remote machine or a node. Multiple nodes can be in the path between any two communicating servers.

FIG. 7B illustrates an example cloud computing environment. A cloud computing environment 701 can provide the client device 106 with one or more resources provided by a network environment. The cloud computing environment 701 can include one or more client devices 106, in communication with the cloud 710 over one or more networks 105. Client devices 106 can include, e.g., thick clients, thin clients, and zero clients. A thick client can provide at least some functionality even when disconnected from the cloud 710 or servers 702. A thin client or a zero client can depend on the connection to the cloud 710 or server 702 to provide functionality. A zero client can depend on the cloud 710 or other networks 105 or servers 702 to retrieve operating system data for the client device. The cloud 710 can include back-end platforms, e.g., the servers 702, storage, server farms or data centers.

The cloud 710 can be public, private, or hybrid. Public clouds can include public servers 702 that are maintained by third parties to the client devices 106 or the owners of the clients. The servers 702 can be located off-site in remote geographical locations as disclosed above or otherwise. Public clouds can be connected to the servers 702 over a public network. Private clouds can include private servers 702 that are physically maintained by client devices 106 or owners of clients. Private clouds can be connected to the servers 702 over a private network 105. Hybrid clouds can include both the private and public networks 105 and servers 702.

The cloud 710 can also include a cloud-based delivery, e.g., Software as a Service (SaaS) 712, Platform as a Service (PaaS) 714, and the Infrastructure as a Service (IaaS) 716. IaaS can refer to a user renting the use of infrastructure resources that are needed during a specified time period. IaaS providers can offer storage, networking, servers, or virtualization resources from large pools, allowing the users to quickly scale up by accessing more resources as needed. PaaS providers can offer functionality provided by IaaS, including, e.g., storage, networking, servers, or virtualization, as well as additional resources such as, e.g., the operating system, middleware, or runtime resources. SaaS providers can offer the resources that PaaS provides, including storage, networking, servers, virtualization, operating system, middleware, or runtime resources. In some embodiments, SaaS providers can offer additional resources including, e.g., data and application resources.

Client devices 106 can access IaaS resources, SaaS resources, or PaaS resources. In embodiments, access to IaaS, PaaS, or SaaS resources can be authenticated. For example, a server or authentication server can authenticate a user via security certificates, HTTPS, or API keys. API keys can include various encryption standards such as, e.g., Advanced Encryption Standard (AES). Data resources can be sent over Transport Layer Security (TLS) or Secure Sockets Layer (SSL), DTLS (Datagram Transport Layer Security), or other transmission mechanisms.

The client device 106 and the server 702 can be deployed as and/or executed on any type and form of computing device, e.g., a computer, network device or appliance capable of communicating on any type and form of network and performing the operations described herein.

FIG. 7C depict a block diagram of the computing device 703 useful for practicing an embodiment of the client device 106 or the server 702. As shown in FIG. 7C, each computing device 703 can include a central processing unit 718, and a main memory unit (shown as memory 720), a computing device 703 can include one or more of a storage device 736, an installation device 732, a network interface 734, an I/O controller 722, a display device 730, a keyboard 724, a pointing device 726 (e.g., a mouse), and an I/O device 728. The storage device 736 can include, without limitation, a program 740, such as an operating system, software, or software associated with system 100.

The central processing unit 718 is any logic circuitry that responds to, and processes instructions fetched from memory 720. The central processing unit 718 can be provided by a microprocessor unit, e.g.: those manufactured by Intel Corporation of Mountain View, California. The computing device 703 can be based on any of these processors, or any other processor capable of operating as described herein. The central processing unit 718 can utilize instruction level parallelism, thread level parallelism, different levels of cache, and multi-core processors. A multi-core processor can include two or more processing units on a single computing component.

Memory 720 can include one or more memory chips capable of storing data and allowing any storage location to be directly accessed by the central processing unit 718. Memory 720 can be volatile and faster than storage device 736. Memory 720 can be Dynamic random-access memory (DRAM) or any variants, including static random access memory (SRAM). Memory 720 or the storage device 736 can be non-volatile; e.g., non-volatile read access memory (NVRAM). Memory 720 can be based on any type of memory chip, or any other available memory chips. In the example depicted in FIG. 7C, the central processing unit 718 can communicate with memory 720 via a system bus 738.

The I/O device 728 can be present in the computing device 703. The I/O device 728 can include keyboards, mice, trackpads, trackballs, touchpads, touch mice, multi-touch touchpads and touch mice, microphones, multi-array microphones, drawing tablets, cameras, or other sensors. The I/O device 728 includes video displays, graphical displays, speakers, headphones, or printers.

The I/O device 728 can have both input and output capabilities, including, e.g., haptic feedback devices, touchscreen displays, or multi-touch displays. Touchscreen, multi-touch displays, touchpads, touch mice, or other touch sensing devices can use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices can allow two or more contact points with the surface, allowing advanced functionality including, e.g., pinch, spread, rotate, scroll, or other gestures. Some touchscreen devices, including, e.g., Microsoft PIXELSENSE or Multi-Touch Collaboration Wall, can have larger surfaces, such as on a table-top or on a wall, and can also interact with other electronic devices. The I/O device 728, the display device 730, or a group of devices can be augmented reality devices. The I/O devices can be controlled by the I/O controller 722 as shown in FIG. 7C. The I/O controller 722 can control one or more I/O devices, such as, e.g., the keyboard 724 and the pointing device 726, e.g., a mouse or optical pen. Furthermore, an I/O device can also provide storage and/or the installation device 732 for the computing device 703. In embodiments, the computing device 703 can provide USB connections (not shown) to receive handheld USB storage devices. In embodiments, the I/O device 728 can be a bridge between the system bus 738 and an external communication bus, e.g., a USB bus, a SCSI bus, a FireWire bus, an Ethernet bus, a Gigabit Ethernet bus, a Fiber Channel bus, or a Thunderbolt bus.

In embodiments, the display device 730 can be connected to the I/O controller 722. Display devices can include, e.g., liquid crystal displays (LCD), electronic papers (e-ink) displays, flexile displays, light emitting diode displays (LED), or other types of displays. In some embodiments, the display device 730 or the I/O controller 722 can be controlled through or have hardware support for OPENGL or DIRECTX API or other graphics libraries. Any of the I/O device 728 and/or the I/O controller 722 can include any type and/or form of suitable hardware, software, or combination of hardware and software to support, enable or provide for the connection and use of one or more display devices (e.g., the display device 730) by the computing device 703. For example, the computing device 703 can include any type and/or form of video adapter, video card, driver, and/or library to interface, communicate, connect, or otherwise use the display devices 730. In embodiments, a video adapter can include multiple connectors to interface to multiple display devices (e.g., the display device 730).

The computing device 703 can include the storage device 736 (e.g., one or more hard disk drives or redundant arrays of independent disks) for storing an operating system or other related software, and for storing application software programs (e.g., the program 740) such as any program related to the systems, methods, components, modules, elements, or functions depicted in FIG. 1. Examples of the storage device 736 include, e.g., hard disk drive (HDD); optical drive including CD drive, DVD drive, or BLU-RAY drive; solid-state drive (SSD); USB flash drive; or any other device suitable for storing data. The storage device 736 can include multiple volatile and non-volatile memories, including, e.g., solid state hybrid drives that combine hard disks with solid state cache. The storage device 736 can be non-volatile, mutable, or read-only. The storage device 736 can be internal and connect to the computing device 703 via the system bus 738. The storage device 736 can be external and connect to the computing device 703 via the I/O device 728 that provides an external bus. The storage device 736 can connect to the computing device 703 via the network interface 734 over a network 105. Some client devices 106 may not require a non-volatile device (e.g., the storage device 736) and can be thin clients or zero client devices 106. The storage device 736 can be used as the installation device 732 and can be suitable for installing software and programs.

The computing device 703 can include the network interface 734 to interface to the network 105 through a variety of connections including, but not limited to, standard telephone lines LAN or WAN links (e.g., 802.11, T1, T3, Gigabit Ethernet, Infiniband), broadband connections (e.g., ISDN, Frame Relay, ATM, Gigabit Ethernet, Ethernet-over-SONET, ADSL, VDSL, BPON, GPON, fiber optical including FiOS), wireless connections, or some combination of any or all of the above. Connections can be established using a variety of communication protocols (e.g., TCP/IP, Ethernet, ARCNET, SONET, SDH, Fiber Distributed Data Interface (FDDI), IEEE 802.11a/b/g/n/ac CDMA, GSM, WiMax and direct asynchronous connections). The computing device 703 can communicate with other computing devices via any type and/or form of gateway or tunneling protocol e.g., Secure Socket Layer (SSL) or Transport Layer Security (TLS), QUIC protocol, or the Citrix Gateway Protocol manufactured by Citrix Systems, Inc. of Ft. Lauderdale, Florida. The network interface 734 can include a built-in network adapter, network interface card, PCMCIA network card, EXPRESSCARD network card, card bus network adapter, wireless network adapter, USB network adapter, modem, or any other device suitable for interfacing the computing device 703 to any type of network capable of communication and performing the operations described herein.

The computing device 703 can operate under the control of an operating system, which controls scheduling of tasks and access to system resources. The computing device 703 can be running any operating system configured for any type of computing device, including, for example, a desktop operating system, a mobile device operating system, a tablet operating system, or a smartphone operating system.

The computing device 703 can be any workstation, telephone, desktop computer, laptop or notebook computer, netbook, ULTRABOOK, tablet, server, handheld computer, mobile telephone, smartphone or other portable telecommunications device, media playing device, a gaming system, mobile computing device, or any other type and/or form of computing, telecommunications or media device that is capable of communication. The computing device 703 has sufficient processor power and memory capacity to perform the operations described herein. In some embodiments, the computing device 703 can have different processors, operating systems, and input devices consistent with the device.

In some embodiments, the status of one or more of the client devices 106 and/or the computing device 703, in the network 105, can be monitored as part of network management. In embodiments, the status of a machine can include an identification of load information (e.g., the number of processes on the machine, CPU and memory utilization), of port information (e.g., the number of available communication ports and the port addresses), or of session status (e.g., the duration and type of processes, and whether a process is active or idle). In another of these embodiments, this information can be identified by a plurality of metrics, and the plurality of metrics can be applied at least in part towards decisions in load distribution, network traffic management, and network failure recovery as well as any aspects of operations of the present solution described herein.

The processes, systems and methods described herein can be implemented by the computing device 703 in response to the central processing unit 718 executing an arrangement of instructions contained in memory 720. Such instructions can be read into memory 720 from another computer-readable medium, such as the storage device 736. Execution of the arrangement of instructions contained in memory 720 causes the computing device 703 to perform the illustrative processes described herein. One or more processors in a multi-processing arrangement may also be employed to execute the instructions contained in memory 720. Hard-wired circuitry can be used in place of or in combination with software instructions together with the systems and methods described herein. Systems and methods described herein are not limited to any specific combination of hardware circuitry and software.

Although an example computing system has been described in FIG. 7A, the subject matter including the operations described in this specification can be implemented in other types of digital electronic circuitry, or in computer software, firmware, or hardware, including the structures disclosed in this specification and their structural equivalents, or in combinations of one or more of them.

At least one aspect is directed to a system. The system can include one or more memory devices. The one or more memory devices can store instructions thereon. The instructions can, when executed by one or more processors, cause the one or more processors to monitor network traffic across a network provided by a first autonomous system. The network traffic can include communication messages of communication sessions between a plurality of computing devices via a network device of the first autonomous system. The instructions can cause the one or more processors to detect, based on at least a portion of the network traffic, an attack on an Internet Protocol (IP) address of the network. The attack can be facilitated by transmission of one or more data packets across the network to a computing device of the plurality of computing devices. The instructions can cause the one or more processors to prompt, responsive to detection of the attack, the network device for one or more flow records that list (i) the IP address of the network as a destination IP address and (ii) the first autonomous system as a destination autonomous system. The instructions can cause the one or more processors to generate, for inclusion in a graph, a first node that comprises at least one of (i) the IP address of the network within the graph or (ii) an identification of the first autonomous system within the graph. The instructions can cause the one or more processors to identify, using at least one flow record of the one or more flow records, one or more second autonomous systems that forwarded the one or more data packets to the first autonomous system. The at least one flow record can list the first autonomous system as a next hop autonomous system. The instructions can cause the one or more processors to generate, responsive to identification of the one or more second autonomous systems, one or more second nodes representative of the one or more second autonomous systems within the graph. The instructions can cause the one or more processors to connect, using one or more edges of the graph, the first node to the one or more second nodes. The one or more edges can indicate that the one or more second autonomous systems forwarded the one or more data packets to the first autonomous system. The instructions can cause the one or more processors to, responsive to determining a source autonomous system of the attack using the one or more edges of the graph, store an association between the attack and an identifier of the source autonomous system.

At least one aspect is directed to a method. The method can include monitoring, by one or more processing circuits, network traffic across a network provided by a first autonomous system. The network traffic can include communication messages of communication sessions between a plurality of computing devices via a network device of the first autonomous system. The method can include detecting, by the one or more processing circuits, based on at least a portion of the network traffic, an attack on an Internet Protocol (IP) address of the network. The attack can be facilitated by transmission of one or more data packets across the network to a computing device of the plurality of computing devices. The method can include prompting, by the one or more processing circuits, responsive to detection of the attack, the network device for one or more flow records that list (i) the IP address of the network as a destination IP address and (ii) the first autonomous system as a destination autonomous system. The method can include generating, by the one or more processing circuits, for inclusion in a graph, a first node that comprises at least one of (i) the IP address of the network within the graph or (ii) an identification of the first autonomous system within the graph. The method can include identifying, by the one or more processing circuits, using at least one flow record of the one or more flow records, one or more second autonomous systems that forwarded the one or more data packets to the first autonomous system. The at least one flow record can list the first autonomous system as a next hop autonomous system. The method can include generating, by the one or more processing circuits, responsive to identifying the one or more second autonomous systems, one or more second nodes representative of the one or more second autonomous systems within the graph. The method can include connecting, by the one or more processing circuits, using one or more edges of the graph, the first node to the one or more second nodes. The one or more edges can indicate that the one or more second autonomous systems forwarded the one or more data packets to the first autonomous system. The method can include, responsive to determining a source autonomous system of the attack using the one or more edges of the graph, storing, by the one or more processing circuits, an association between the attack and an identifier of the source autonomous system.

At least one aspect is directed to a non-transitory computer readable storage medium. The non-transitory computer readable storage medium can include instructions stored thereon. The instructions can, when executed by one or more processors, cause the one or more processors to perform operations that include monitoring network traffic across a network provided by a first autonomous system. The network traffic can include communication messages of communication sessions between a plurality of computing devices via a network device of the first autonomous system. The operations can include detecting, based on at least a portion of the network traffic, an attack on an Internet Protocol (IP) address of the network. The attack can be facilitated by transmission of one or more data packets across the network to a computing device of the plurality of computing devices. The operations can include prompting, responsive to detecting the attack, the network device for one or more flow records that list (i) the IP address of the network as a destination IP address and (ii) the first autonomous system as a destination autonomous system. The operations can include generating, for inclusion in a graph, a first node that comprises at least one of (i) the IP address of the network within the graph or (ii) an identification of the first autonomous system within the graph. The operations can include identifying, using at least one flow record of the one or more flow records, one or more second autonomous systems that forwarded the one or more data packets to the first autonomous system. The at least one flow record can list the first autonomous system as a next hop autonomous system. The operations can include generating, responsive to identifying the one or more second autonomous systems, one or more second nodes representative of the one or more second autonomous systems within the graph. The operations can include connecting, using one or more edges of the graph, the first node to the one or more second nodes. The one or more edges can indicate that the one or more second autonomous systems forwarded the one or more data packets to the first autonomous system. The operations can include, responsive to determining a source autonomous system of the attack using the one or more edges of the graph, storing an association between the attack and an identifier of the source autonomous system.

The foregoing detailed description includes illustrative examples of various aspects and embodiments and provides an overview or framework for understanding the nature and character of the claimed aspects and embodiments. The drawings provide illustration and a further understanding of the various aspects and embodiments and are incorporated in and constitute a part of this specification.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices). The operations described in this specification can be implemented as operations performed by a data processing apparatus on data stored on one or more computer-readable storage devices or received from other sources.

The terms “computing device” or “component” encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing, and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file on a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs (e.g., components of the data processing system 110) to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data include all forms of non-volatile memory, media, and memory devices, including by way of example semiconductor memory devices, e.g., EPROM, EEPROM, and flash memory devices; magnetic disks, e.g., internal hard disks or removable disks; magneto optical disks. The processor and the memory can be supplemented by, or incorporated in, special purpose logic circuitry.

While operations are depicted in the drawings in a particular order, such operations are not required to be performed in the particular order shown or in sequential order, and all illustrated operations are not required to be performed. Actions described herein can be performed in a different order. The separation of various system components does not require separation in all embodiments, and the described program components can be included in a single hardware or software product.

The phraseology and terminology used herein is for the purpose of description and should not be regarded as limiting. Any references to embodiments or elements or acts of the systems and methods herein referred to in the singular may also embrace embodiments including a plurality of these elements, and any references in plural to any implementation or element or act herein may also embrace embodiments including only a single element. Any implementation disclosed herein may be combined with any other implementation or embodiment.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A,’ only ‘B,’ as well as both ‘A’ and ‘B.’ Such references used in conjunction with “comprising” or other open terminology can include additional items.

The foregoing embodiments are illustrative rather than limiting of the described systems and methods. Scope of the systems and methods described herein is thus indicated by the appended claims, rather than the foregoing description, and changes that come within the meaning and range of equivalency of the claims are embraced therein.

What is claimed is:

1. A system comprising one or more memory devices storing instructions thereon that, when executed by one or more processors, cause the one or more processors to:
monitor network traffic across a network provided by a first autonomous system, the network traffic comprising communication messages of communication sessions between a plurality of computing devices via a network device of the first autonomous system;
detect, based on at least a portion of the network traffic, an attack on an Internet Protocol (IP) address of the network, the attack facilitated by transmission of one or more data packets across the network to a computing device of the plurality of computing devices;
prompt, responsive to detection of the attack, the network device for one or more flow records that list (i) the IP address of the network as a destination IP address and (ii) the first autonomous system as a destination autonomous system;
generate, for inclusion in a graph, a first node that comprises at least one of (i) the IP address of the network within the graph or (ii) an identification of the first autonomous system within the graph;
identify, using at least one flow record of the one or more flow records, one or more second autonomous systems that forwarded the one or more data packets to the first autonomous system, wherein the at least one flow record lists the first autonomous system as a next hop autonomous system;
generate, responsive to identification of the one or more second autonomous systems, one or more second nodes representative of the one or more second autonomous systems within the graph;
connect, using one or more edges of the graph, the first node to the one or more second nodes, wherein the one or more edges indicate that the one or more second autonomous systems forwarded the one or more data packets to the first autonomous system; and
responsive to determining a source autonomous system of the attack using the one or more edges of the graph, store an association between the attack and an identifier of the source autonomous system.

2. The system of claim 1, wherein the instructions further cause the one or more processors to:
prompt, responsive to generation of the one or more second nodes, a second network device associated with the one or more second autonomous systems for one or more second flow records that list (i) the IP address of the network as the destination IP address and (ii) the one or more second autonomous systems as the next hop autonomous system;
identify, using the one or more second flow records, one or more third autonomous systems that forwarded the one or more data packets to the one or more second autonomous systems; and
generate, responsive to identification of the one or more third autonomous systems, one or more third nodes that represent the one or more third autonomous systems within the graph.

3. The system of claim 1, wherein the instructions further cause the one or more processors to:
receive one or more second flow records associated with one or more second data packets forwarded to the one or more second autonomous systems;
determine, responsive to a search of the one or more second flow records, that the one or more second autonomous systems are not listed as the next hop autonomous system; and
prevent subsequent generation of one or more third nodes for the graph given that the one or more second autonomous systems are not listed as the next hop autonomous system.

4. The system of claim 1, wherein the instructions further cause the one or more processors to:
search one or more second flow records of the one or more second autonomous systems;
determine, responsive to the search, that the one or more second autonomous systems are not listed as the next hop autonomous system; and
identify, using outbound flow records of the one or more second autonomous systems, the one or more second autonomous systems as the source autonomous system;
wherein the one or more second autonomous systems are determined to be the source autonomous system based on the outbound flow records listing the one or more second autonomous systems as a previous hop autonomous system.

5. The system of claim 1, wherein the instructions further cause the one or more processors to:
determine, responsive to a search of one or more second flow records, that the one or more second autonomous systems are not listed as the next hop autonomous system;
search outbound flow records of the one or more second autonomous systems to identify a previous hop autonomous system, wherein one or more third autonomous systems are listed as the previous hop autonomous system; and
identify the one or more third autonomous systems as the source autonomous system based on the one or more third autonomous systems being listed as the previous hop autonomous system.

6. The system of claim 1, wherein the instructions further case the one or more processors to:
label, responsive to generation of the first node, the first node according to an autonomous system number for the first autonomous system, wherein the autonomous system number includes the identification of the first autonomous system, and wherein the label of the first node is visible upon display of the graph via a graphical user interface; and
connect the first node to the one or more second nodes such that (i) the one or more edges lead from the one or more second nodes to the first node and (ii) the one or more edges are labeled to show the first autonomous system as the next hop autonomous system.

7. The system of claim 1, wherein the instructions further cause the one or more processors to:
build up the graph by connecting one or more third nodes to the one or more second nodes via one or more second edges, wherein the one or more second edges indicate that the one or more second autonomous systems are listed as the next hop autonomous system in one or more second flow records, and wherein the one or more third nodes represent one or more third autonomous systems that forwarded the one or more data packets to the one or more second autonomous systems;
detect, responsive to building up the graph, at least one gap in the graph, wherein the at least one gap is based on the graph including at least one fourth node that is not connected to at least one of the one or more second nodes or the one or more third nodes; and
resolve the at least one gap by:
retrieving, from a data source, a table that includes peering relationships between a plurality of autonomous systems, wherein the plurality of autonomous systems include at least one of the first autonomous system, the one or more second autonomous systems, or the one or more third autonomous systems; and
identifying at least one autonomous systems of the plurality of autonomous systems that (i) forwarded the one or more data packets to the one or more second autonomous systems or (ii) forwarded the one or more data packets to the one or more third autonomous systems.

8. The system of claim 1, wherein the attack is facilitated in accordance with at least one protocol and at least one attack type, and wherein the instructions further cause the one or more processors to:
filter the one or more flow records using the at least one protocol and the at least one attack type;
identify the at least one flow record; and
filter one or more second flow records to identify one or more third autonomous systems that forwarded the one or more data packets.

9. A method, comprising:
monitoring, by one or more processing circuits, network traffic across a network provided by a first autonomous system, the network traffic comprising communication messages of communication sessions between a plurality of computing devices via a network device of the first autonomous system;
detecting, by the one or more processing circuits, based on at least a portion of the network traffic, an attack on an Internet Protocol (IP) address of the network, the attack facilitated by transmission of one or more data packets across the network to a computing device of the plurality of computing devices;
prompting, by the one or more processing circuits, responsive to detection of the attack, the network device for one or more flow records that list (i) the IP address of the network as a destination IP address and (ii) the first autonomous system as a destination autonomous system;
generating, by the one or more processing circuits, for inclusion in a graph, a first node that comprises at least one of (i) the IP address of the network within the graph or (ii) an identification of the first autonomous system within the graph;
identifying, by the one or more processing circuits, using at least one flow record of the one or more flow records, one or more second autonomous systems that forwarded the one or more data packets to the first autonomous system, wherein the at least one flow record lists the first autonomous system as a next hop autonomous system;
generating, by the one or more processing circuits, responsive to identifying the one or more second autonomous systems, one or more second nodes representative of the one or more second autonomous systems within the graph;
connecting, by the one or more processing circuits, using one or more edges of the graph, the first node to the one or more second nodes, wherein the one or more edges indicate that the one or more second autonomous systems forwarded the one or more data packets to the first autonomous system; and
responsive to determining a source autonomous system of the attack using the one or more edges of the graph, storing, by the one or more processing circuits, an association between the attack and an identifier of the source autonomous system.

10. The method of claim 9, further comprising:
prompting, by the one or more processing circuits, responsive to generating the one or more second nodes, a second network device associated with the one or more second autonomous systems for one or more second flow records that list (i) the IP address of the network as the destination IP address and (ii) the one or more second autonomous systems as the next hop autonomous system;
identifying, by the one or more processing circuits, using the one or more second flow records, one or more third autonomous systems that forwarded the one or more data packets to the one or more second autonomous systems; and
generating, by the one or more processing circuits, responsive to identifying the one or more third autonomous systems, one or more third nodes that represent the one or more third autonomous systems within the graph.

11. The method of claim 9, further comprising:
receiving, by the one or more processing circuits, one or more second flow records associated with one or more second data packets forwarded to the one or more second autonomous systems;
determining, by the one or more processing circuits, responsive to searching the one or more second flow records, that the one or more second autonomous systems are not listed as the next hop autonomous system; and
preventing, by the one or more processing circuits, subsequent generation of one or more third nodes for the graph given that the one or more second autonomous systems are not listed as the next hop autonomous system.

12. The method of claim 9, further comprising:
searching, by the one or more processing circuits, one or more second flow records of the one or more second autonomous systems;
determining, by the one or more processing circuits, responsive to searching the one or more second flow records, that the one or more second autonomous systems are not listed as the next hop autonomous system; and
identifying, by the one or more processing circuits, using outbound flow records of the one or more second autonomous systems, the one or more second autonomous systems as the source autonomous system;
wherein the one or more second autonomous systems are determined to be the source autonomous system based on the outbound flow records listing the one or more second autonomous systems as a previous hop autonomous system.

13. The method of claim 9, further comprising:
determining, by the one or more processing circuits, responsive to searching one or more second flow records, that the one or more second autonomous systems are not listed as the next hop autonomous system;
searching, by the one or more processing circuits, outbound flow records of the one or more second autonomous systems to identify a previous hop autonomous system, wherein one or more third autonomous systems are listed as the previous hop autonomous system; and
identifying, by the one or more processing circuits, the one or more third autonomous systems as the source autonomous system based on the one or more third autonomous systems being listed as the previous hop autonomous system.

14. The method of claim 9, further comprising:
labeling, by the one or more processing circuits, responsive to generating the first node, the first node according to an autonomous system number for the first autonomous system, wherein the autonomous system number includes the identification of the first autonomous system, and wherein a label of the first node is visible upon display of the graph via a graphical user interface; and
connecting, by the one or more processing circuits, the first node to the one or more second nodes such that (i) the one or more edges lead from the one or more second nodes to the first node and (ii) the one or more edges are labeled to show the first autonomous system as the next hop autonomous system.

15. The method of claim 9, further comprising:
building up, by the one or more processing circuits, the graph by connecting one or more third nodes to the one or more second nodes via one or more second edges, wherein the one or more second edges indicate that the one or more second autonomous systems are listed as the next hop autonomous system in one or more second flow records, and wherein the one or more third nodes represent one or more third autonomous systems that forwarded the one or more data packets to the one or more second autonomous systems;
detecting, by the one or more processing circuits, responsive to building up the graph, at least one gap in the graph, wherein the at least one gap is based on the graph including at least one fourth node that is not connected to at least one of the one or more second nodes or the one or more third nodes; and
resolving, by the one or more processing circuits, the at least one gap by:
retrieving, from a data source, a table that includes peering relationships between a plurality of autonomous systems, wherein the plurality of autonomous systems include at least one of the first autonomous system, the one or more second autonomous systems, or the one or more third autonomous systems; and
identifying at least one autonomous systems of the plurality of autonomous systems that (i) forwarded the one or more data packets to the one or more second autonomous systems or (ii) forwarded the one or more data packets to the one or more third autonomous systems.

16. The method of claim 9, wherein the attack is facilitated in accordance with at least one protocol and at least one attack type, and further comprising:
filtering, by the one or more processing circuits, the one or more flow records using the at least one protocol and the at least one attack type;
identifying, by the one or more processing circuits, the at least one flow record; and
filtering, by the one or more processing circuits, one or more second flow records to identify one or more third autonomous systems that forwarded the one or more data packets.

17. One or more non-transitory storage medium storing one or more instructions thereon that, when executed by one or more processors, cause the one or more processors to perform operations comprising:
monitoring network traffic across a network provided by a first autonomous system, the network traffic comprising communication messages of communication sessions between a plurality of computing devices via a network device of the first autonomous system;
detecting, based on at least a portion of the network traffic, an attack on an Internet Protocol (IP) address of the network, the attack facilitated by transmission of one or more data packets across the network to a computing device of the plurality of computing devices;
prompting, responsive to detecting the attack, the network device for one or more flow records that list (i) the IP address of the network as a destination IP address and (ii) the first autonomous system as a destination autonomous system;
generating, for inclusion in a graph, a first node that comprises at least one of (i) the IP address of the network within the graph or (ii) an identification of the first autonomous system within the graph;
identifying, using at least one flow record of the one or more flow records, one or more second autonomous systems that forwarded the one or more data packets to the first autonomous system, wherein the at least one flow record lists the first autonomous system as a next hop autonomous system;
generating, responsive to identifying the one or more second autonomous systems, one or more second nodes representative of the one or more second autonomous systems within the graph;
connecting, using one or more edges of the graph, the first node to the one or more second nodes, wherein the one or more edges indicate that the one or more second autonomous systems forwarded the one or more data packets to the first autonomous system; and
responsive to determining a source autonomous system of the attack using the one or more edges of the graph, storing an association between the attack and an identifier of the source autonomous system.

18. The one or more non-transitory storage medium of claim 17, wherein the one or more instructions further cause the one or more processors to perform operations comprising:
prompting, responsive to generating the one or more second nodes, a second network device associated with the one or more second autonomous systems for one or more second flow records that list (i) the IP address of the network as the destination IP address and (ii) the one or more second autonomous systems as the next hop autonomous system;
identifying, using the one or more second flow records, one or more third autonomous systems that forwarded the one or more data packets to the one or more second autonomous systems; and
generating, responsive to identifying the one or more third autonomous systems, one or more third nodes that represent the one or more third autonomous systems within the graph.

19. The one or more non-transitory storage medium of claim 17, wherein the one or more instructions further cause the one or more processors to perform operations comprising:
receiving one or more second flow records associated with one or more second data packets forwarded to the one or more second autonomous systems;
determining, responsive to a search of the one or more second flow records, that the one or more second autonomous systems are not listed as the next hop autonomous system; and
preventing subsequent generation of one or more third nodes for the graph given that the one or more second autonomous systems are not listed as the next hop autonomous system.

20. The one or more non-transitory storage medium of claim 17, wherein the one or more instructions further cause the one or more processors to perform operations comprising:
searching one or more second flow records of the one or more second autonomous systems;
determining, responsive to searching the one or more second flow records, that the one or more second autonomous systems are not listed as the next hop autonomous system; and
identifying, using outbound flow records of the one or more second autonomous systems, the one or more second autonomous systems as the source autonomous system;
wherein the one or more second autonomous systems are determined to be the source autonomous system based on the outbound flow records listing the one or more second autonomous systems as a previous hop autonomous system.
